(19) United States
(12) Patent Application Publication
(10) Pub. No.: US 2026/0276076 A1
(43) Pub. Date: Sep. 17, 2026

(54) LUBRICATION STRUCTURE FOR PLANETARY GEAR APPARATUS

(71) Applicant: Hyundai Transys Inc., Seosan-si (KR)

(72) Inventor: TAE HOON KIM, Hwaseong-si (KR)

(21) Appl. No.: 19/076,146

(22) Filed: Mar. 11, 2025

(51) Int. Cl. F16H 57/04

(52) U.S. Cl. CPC F16H 57/0486; F16H 57/0427; F16H 57/043; F16H 57/0471; F16H 57/0479

(57) ABSTRACT

A lubrication structure for a planetary gear apparatus includes a pinion shaft having a first discharge hole bored in the pinion shaft in a direction toward a sun gear, and a second discharge hole bored in the pinion shaft in a direction opposite to the sun gear, and an oil guide device coupled to the pinion shaft and configured to guide collected oil to the first discharge hole or the second discharge hole.

### TECHNICAL FIELD

The present invention relates to a lubrication structure for a planetary gear apparatus.

### BACKGROUND ART

In general, a lubrication device for an automatic transmission may include a pinion gear part having a pinion shaft and a pinion gear configured to surround the pinion shaft, a ring gear part configured to engage with the pinion gear, a first thrust bearing coupled to the ring gear part, a second thrust bearing disposed at one side of the pinion gear, an oil guide coupled to the pinion shaft and configured to guide oil, which scatters from the first thrust bearing, to the pinion shaft, a sun gear configured to engage with the pinion gear and having a first oil hole portion, through which the oil passes, and a second oil hole portion configured to supply the oil to the second thrust bearing, and a carrier coupled to the pinion shaft and having a third oil hole portion configured to receive the oil from the first oil hole portion and deliver the oil to the first thrust bearing, and a fourth oil hole portion configured to receive the oil from the second thrust bearing and deliver the oil to the oil guide.

In case that the carrier cannot rotate or the carrier is stopped at a particular gear shift position of the automatic transmission without rotating in the lubrication device for an automatic transmission in the related art, the oil scattering from a central axis is not supplied to the bearing through the oil guide, which damages (flakes) a surface of the bearing.

### DOCUMENT OF RELATED ART

### Patent Document

(Patent Document 1) Korean Patent Application Laid-Open No. 10-2021-0049483 (published on May 6, 2021)

### SUMMARY OF THE INVENTION

The present invention has been made in an effort to provide a lubrication structure for a planetary gear apparatus, the lubrication structure being capable of smoothly supplying oil, which is collected by an oil guide device, to a lubrication target through a first discharge hole or a second discharge hole of a pinion shaft regardless of whether a carrier is stopped.

In order to achieve the above-mentioned object, the present invention provides a lubrication structure for a planetary gear apparatus, the lubrication structure including: a pinion shaft having a first discharge hole bored in the pinion shaft in a direction toward a sun gear, and a second discharge hole bored in the pinion shaft in a direction opposite to the sun gear; and an oil guide device coupled to the pinion shaft and configured to guide collected oil to the first discharge hole or the second discharge hole.

In addition, the oil guide device may include: a first ring part disposed adjacent to the pinion shaft; a second ring part provided at an interval from the first ring part; and a pipe part protruding from one surface of the first ring part in a direction toward the pinion shaft and inserted into the pinion shaft, and the inside of the pipe part may be divided by a partition wall into a first passageway disposed adjacent to the first discharge hole, and a second passageway disposed adjacent to the second discharge hole.

In addition, a first collection part, which is connected to the first passageway from an inner-diameter portion of the first ring part and an inner-diameter portion of the second ring part, and a second collection part, which is connected to the second passageway from an outer-diameter portion of the first ring part and an outer-diameter portion of the second ring part, may be defined by the interval between the first ring part and the second ring part.

In addition, the sun gear may have at least one first oil hole, and a second oil hole, which connects the first oil hole and the first collection part, may be provided in a portion of a carrier positioned between the sun gear and the pinion shaft.

In addition, the oil introduced into the first oil hole may be supplied to a lubrication target through the second discharge hole via the second oil hole, the first collection part, and the first passageway.

In addition, the oil introduced into the second collection part may be supplied to a lubrication target through the first discharge hole via the second passageway.

In addition, the lubrication target may be a bearing or a pinion gear.

In addition, a bearing may be coupled to an outer-diameter portion of the pinion shaft, a pinion gear may be coupled to an outer-diameter portion of the bearing, and the pinion gear may be rotatable about the sun gear in a state in which an outer-diameter portion of the pinion gear engages with an outer-diameter portion of the sun gear.

In addition, a ring gear may be coupled to surround the pinion gear, and an inner-diameter portion of the ring gear may engage with the outer-diameter portion of the pinion gear.

A coupling pin may be coupled to penetrate a carrier and the pinion shaft from the outside of the carrier in a state in which one end of the pinion shaft is penetratively coupled to the carrier.

According to the present invention, the oil collected by the oil guide device is supplied through the first discharge hole or the second discharge hole of the pinion shaft, such that the oil may be smoothly supplied to the lubrication target regardless of whether the carrier is stopped.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is an overall configuration view of a lubrication structure for a planetary gear apparatus according to an exemplary embodiment of the present invention.

FIG. 2 is a view illustrating an oil guide device according to the exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings. First, in assigning reference numerals to constituent elements of the respective drawings, it should be noted that the same constituent elements will be designated by the same reference numerals, if possible, even though the constituent elements are illustrated in different drawings. In addition, in the description of the present invention, the specific descriptions of publicly known related configurations or functions will be omitted when it is determined that the specific descriptions may obscure the subject matter of the present invention. Further, the exemplary embodiments of the present invention will be described below, but the technical spirit of the present invention is not limited thereto and may, of course, be modified and variously carried out by those skilled in the art.

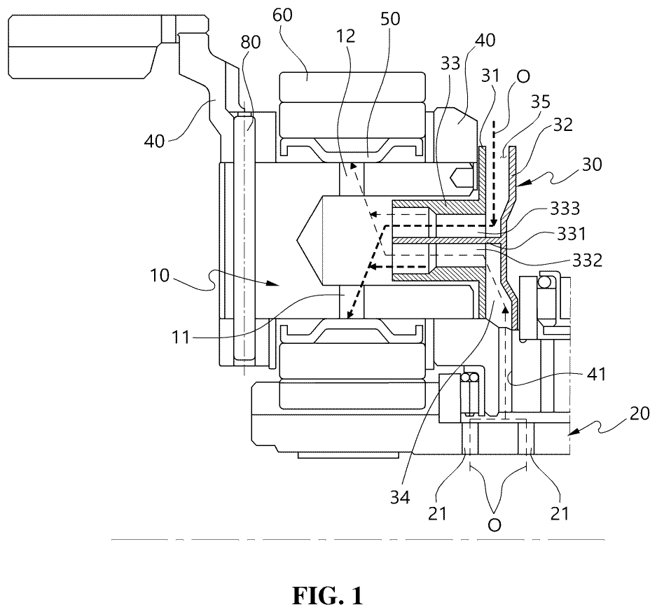

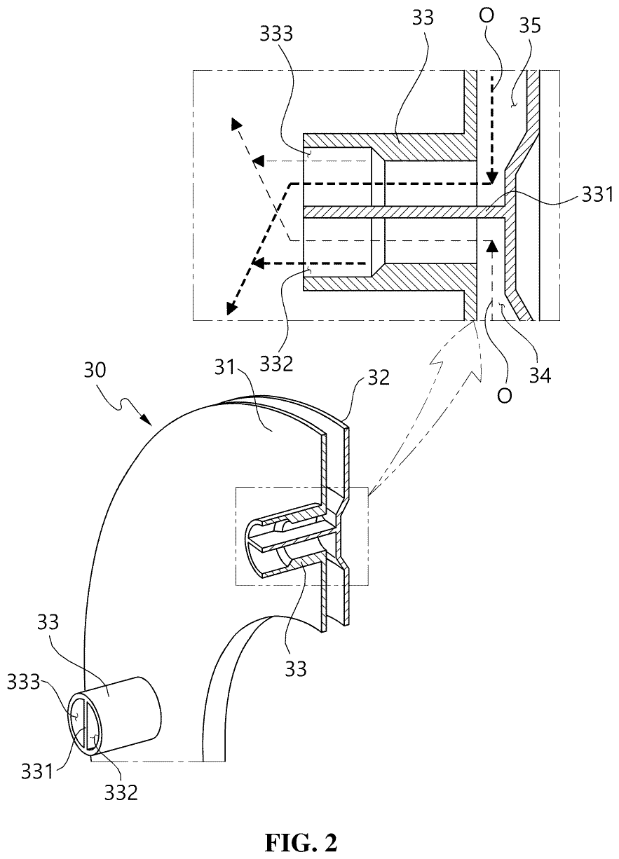

FIG. 1 is an overall configuration view of a lubrication structure for a planetary gear apparatus according to an exemplary embodiment of the present invention, and FIG. 2 is a view illustrating an oil guide device according to the exemplary embodiment of the present invention.

As illustrated in FIGS. 1 and 2, the lubrication structure for a planetary gear apparatus of the present invention may include a pinion shaft 10, and an oil guide device 30 coupled to the pinion shaft 10 and configured to supply collected oil O into the pinion shaft 10.

The pinion shaft 10 may be configured as a hollow shaft. The pinion shaft 10 may include a first discharge hole 11 and a second discharge hole 12.

The first discharge hole 11 may be bored in the pinion shaft 10 in a direction toward a sun gear 20. The oil O introduced into the pinion shaft 10 may fall toward the first discharge hole 11 at the lower side in a state in which a carrier 40 is stopped, and the oil O may be supplied to a lubrication target through the first discharge hole 11.

The second discharge hole 12 may be bored in the pinion shaft 10 in a direction opposite to the sun gear 20. The oil O introduced into the pinion shaft 10 may be supplied to the lubrication target through the second discharge hole 12 by a centrifugal force applied to the pinion shaft 10 when the carrier 40 rotates.

For example, the lubrication target may be a bearing and a pinion gear.

The oil guide device 30 may include a first ring part 31, a second ring part 32, a pipe part 33, a first collection part 34, and a second collection part 35.

The first ring part 31 may be configured as a flat plate with a ring shape. The first ring part 31 may be disposed adjacent to the pinion shaft 10.

The second ring part 32 may be configured as a flat plate with a ring shape. The second ring part 32 may be provided at an interval from the first ring part 31.

The pipe part 33 may protrude from one surface of the first ring part 31 in a direction toward the pinion shaft 10. The pipe part 33 may be inserted and coupled into the pinion shaft 10.

The inside of the pipe part 33 may be divided into a first passageway 332 and a second passageway 333 by a partition wall 331. The first passageway 332 may be disposed adjacent to the first discharge hole 11. The second passageway 333 may be disposed adjacent to the second discharge hole 12.

The first collection part 34 and the second collection part 35 may be defined by an interval between the first ring part 31 and the second ring part 32.

The first collection part 34 may be connected to the first passageway 332 from an inner-diameter portion of the first ring part 31 and an inner-diameter portion of the second ring part 32. The oil O introduced into the first collection part 34 may be introduced into the pinion shaft 10 through the first passageway 332 and discharged to the second discharge hole 12.

The second collection part 35 may be connected to the second passageway 333 from an outer-diameter portion of the first ring part 31 and an outer-diameter portion of the second ring part 32. The oil O introduced into the second collection part 35 may be introduced into the pinion shaft 10 through the second passageway 333 and discharged to the first discharge hole 11.

The sun gear 20 may have at least one first oil hole 21. A second oil hole 41 may be provided in a portion of the carrier 40 positioned between the sun gear 20 and the pinion shaft 10. The first oil hole 21 and the first collection part 34 may be connected by the second oil hole 41.

A bearing 50 may be coupled to an outer-diameter portion of the pinion shaft 10. A pinion gear 60 may be coupled to an outer-diameter portion of the bearing 50. The pinion gear 60 may rotate about the sun gear 20 in a state in which an outer-diameter portion of the pinion gear 60 engages with an outer-diameter portion of the sun gear 20.

A ring gear (not illustrated) may be coupled to surround the pinion gear 60. An inner-diameter portion of the ring gear (not illustrated) may engage with the outer-diameter portion of the pinion gear 60.

The pinion shaft 10 may be connected to the carrier 40 by a coupling pin 80. In a state in which one end of the pinion shaft 10 is inserted into the carrier 40, the coupling pin 80 may be coupled to penetrate the carrier 40 and the pinion shaft 10 from the outside of the carrier 40.

The other end of the pinion shaft 10 may be coupled to penetrate a center of the bearing 50.

Next, a flow of oil introduced into the first collection part of the present invention will be described.

As illustrated in FIGS. 1 and 2, when the carrier 40 rotates, the pinion shaft 10 coupled to the carrier 40 may rotate about the sun gear 20 together with the pinion gear 60.

In the state in which the carrier 40 rotates, the oil O introduced into the sun gear 20 may flow to the first collection part 34 through the first oil hole 21 and the second oil hole 41.

The oil O flowing to the first collection part 34 may collide with the partition wall 331 and move to the first passageway 332. The partition wall 331 may serve to guide and move the oil O to the first passageway 332 while preventing the oil O introduced into the first passageway 332 from moving to the second passageway 333.

The oil O in the first passageway 332 moves into the pinion shaft 10. When the carrier 40 rotates, the oil O may be discharged through the second discharge hole 12 by a centrifugal force applied to the pinion shaft 10.

The oil O discharged through the second discharge hole 12 may be supplied to the lubrication target such as the bearing 50 or the pinion gear 60.

Next, a flow of oil introduced into the second collection part of the present invention will be described.

As illustrated in FIGS. 1 and 2, the carrier 40 may be stopped without rotating at a particular gear shift position of an automatic transmission.

In the state in which the carrier 40 is stopped, the oil O introduced into the second collection part 35 may collide with the partition wall 331 and move to the second passageway 333.

Because the carrier 40 is stopped and no centrifugal force is applied to the pinion shaft 10, the oil O flowing to the second passageway 333 may move into the pinion shaft 10 and move to the first discharge hole 11 at the lower side.

The oil O flowing to the first discharge hole 11 may be supplied to the lubrication target through the first discharge hole 11.

As described above, according to the present invention, the oil collected by the oil guide device is supplied through the first discharge hole or the second discharge hole of the pinion shaft, such that the oil may be smoothly supplied to the lubrication target regardless of whether the carrier is stopped.

The above description is simply given for illustratively describing the technical spirit of the present invention, and those skilled in the art to which the present invention pertains will appreciate that various modifications, changes, and substitutions are possible without departing from the essential characteristics of the present invention. Accordingly, the embodiments disclosed in the present invention and the accompanying drawings are intended not to limit but to describe the technical spirit of the present invention, and the scope of the technical spirit of the present invention is not limited by the embodiments and the accompanying drawings. The protective scope of the present invention should be construed based on the following claims, and all the technical spirit in the equivalent scope thereto should be construed as falling within the scope of the present invention.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

### DESCRIPTION OF REFERENCE NUMERALS

10: Pinion shaft
11: First discharge hole
12: Second discharge hole
20: Sun gear
21: First oil hole
30: Oil guide device
31: First ring part
32: Second ring part
33: Pipe part
331: Partition wall
332: First passageway
333: Second passageway
34: First collection part
35: Second collection part
40: Carrier
41: Second oil hole
50: Bearing
60: Pinion gear
80: Coupling pin
O: Oil

1. A lubrication structure for a planetary gear apparatus, the lubrication structure comprising:
a pinion shaft having a first discharge hole defined in the pinion shaft in a direction toward a sun gear, and a second discharge hole defined in the pinion shaft in a direction opposite to the sun gear; and
an oil guide device coupled to the pinion shaft and configured to guide collected oil to the first discharge hole or the second discharge hole,
wherein the oil guide device comprises:
a first ring part disposed adjacent to the pinion shaft;
a second ring part disposed at an interval from the first ring part; and
a pipe part protruding from one surface of the first ring part in a direction toward the pinion shaft, the pipe part being positioned in the pinion shaft,
wherein an inside of the pipe part is divided by a partition wall into a first passageway disposed adjacent to the first discharge hole, and a second passageway disposed adjacent to the second discharge hole,
wherein a first collection part, which is connected to the first passageway from an inner-diameter portion of the first ring part and an inner-diameter portion of the second ring part, and a second collection part, which is connected to the second passageway from an outer-diameter portion of the first ring part and an outer-diameter portion of the second ring part, are defined by the interval between the first ring part and the second ring part, and
wherein the sun gear has at least one first oil hole and a second oil hole, the second oil hole connecting the at least one first oil hole and the first collection part, the second oil hole being defined in a portion of a carrier positioned between the sun gear and the pinion shaft.

2. (canceled)

3. (canceled)

4. (canceled)

5. The lubrication structure of claim 1, wherein the lubrication structure is configured to supply oil introduced into the at least one first oil hole to a lubrication target through the second discharge hole via the second oil hole, the first collection part, and the first passageway.

6. The lubrication structure of claim 1, wherein the lubrication structure is configured to supply oil introduced into the second collection part to a lubrication target through the first discharge hole via the second passageway.

7. The lubrication structure of claim 5, wherein the lubrication target is a bearing or a pinion gear.

8. The lubrication structure of claim 1, wherein a bearing is coupled to an outer-diameter portion of the pinion shaft, a pinion gear is coupled to an outer-diameter portion of the bearing, and the pinion gear is rotatable about the sun gear in a state in which an outer-diameter portion of the pinion gear engages with an outer-diameter portion of the sun gear.

9. The lubrication structure of claim 8, wherein a ring gear is coupled to surround the pinion gear, and an inner-diameter portion of the ring gear is configured to engage with the outer-diameter portion of the pinion gear.

10. The lubrication structure of claim 1, wherein a coupling pin is configured to be coupled to the carrier and the pinion shaft from an outside of the carrier in a state in which one end of the pinion shaft is inserted into the carrier.
